(19) United States
(12) Patent Application Publication
(10) Pub. No.: US 2008/0235093 A1
(43) Pub. Date: Sep. 25, 2008

(54) MOBILE PHONE IMAGE PROCESSING FOR PROMOTIONAL ENTERPRISE

(75) Inventor: David M. Uland, Granville, OH (US)

Correspondence Address: Stephen B. Salai, Esq.;Harter, Secrest & Emery LLP, 1600 Bausch & Lomb Place, Rochester, NY, 14604-2711, US

(73) Assignee: W.S. PACKAGING GROUP, INC., Algoma, WI (US)

(21) Appl. No.: 12/053,301

(22) Filed: Mar. 21, 2008

Related U.S. Application Data
(60) Provisional application No. 60/896,323, filed on Mar. 22, 2007.

(51) Int. Cl. G06Q 30/00

(52) U.S. Cl. 705/14

(57) ABSTRACT

A promotional system initiated by capturing encoded images with mobile phones supports interactions between customers and vendors. A host site receives and decodes an information-bearing image captured with a customer's mobile phone. The image preferably appears on a vendor's product or place of business, such as a retail outlet. The host site also acquires information distinguishing the customer, such as the customer's telephone number or location. The information extracted from the information-bearing image is processed together with the information from the customer and a reply is sent to the customer to engage the customer in a promotion.

### TECHNICAL FIELD

The invention relates to promotional systems, including interactive games, involving remote data exchanges between participants and one or more hosts, initiated through the image transmissions by mobile phones.

### BACKGROUND OF THE INVENTION

A number of commercially sponsored games are ongoing for promoting products and brands. One such game mounts removable game pieces on product containers, and the removed game pieces can be collected in various combinations for winning prizes or instantly redeemed for receiving products or points having other potential value. The game pieces can be expensive to print and must remain hidden to prevent the identification of the more valuable pieces. Also, the game provides only limited feedback concerning the game participants.

Other games print hidden codes, whose potential value can be ascertained over an internet connection. For example, such as codes have been printed inside bottle caps. Participants can sign onto such online promotional enterprises and earn various rewards by entering the hidden codes. These known systems have relatively limited response rates and generally require the code information to be manually entered, often at an internet site remote from the point of purchase.

Camera phones have become near ubiquitous and provide a variety of potential communication links via telephone and internet connections. Many mobile phones are equipped with cameras that capture images that can be sent to other mobile phones or internet addresses. This ability carries with it the potential for other useful applications.

### SUMMARY OF THE INVENTION

The invention exploits the capability of mobile phone cameras for capturing information-bearing images and provides for extracting and using the extracted information to trigger actions on behalf of the phone user. However, the processing capabilities of current mobile phones are generally limited and vary among mobile phone models. Some mobile phone models restrict the download of new software capabilities. Mobile phone processors and operating systems also tend to vary between mobile phone manufacturers, and as a result, new software capabilities are difficult to add to the current generation of mobile phones.

Accordingly, the invention provides for extracting information from information-bearing images captured by mobile phones at remote host sites placed in communication with mobile phones. For example, a mobile phone could be used for capturing an information-bearing image, and the mobile phone user could send the captured image to a given telephone number or an internet address much as the user would send a picture to another phone. The host site receives not only the intended information-bearing image but also information concerning the sender (the mobile phone user), such as a telephone number and information about the route of the call to the host site. With this information, the host site can process the information-bearing image and instantly reply to the sender to engage the sender in a game or other promotion.

Upon extracting information from the information-bearing image, the host site can acknowledge receipt of the information-bearing image and provide the sender (now a participant) with a relevant response, such as triggering some sort of promotional award, or providing instructions to the sender for further participation. In addition, the host could create or access a unique webpage for the sender as a participant, link the information from the information-bearing image or an assigned derivative of the information to the sender's webpage, and provide information to the sender about how to access the new webpage or any updates made to the page. If the sender's phone is equipped with an internet browser, the phone's browser could be directed to the webpage.

The webpage made available to the sender can be chosen from a number of optional web sites based on the information from the information-bearing image or the accompanying identifying information about the sender. If the sender has already established an online account from a previous transmission, the sender's webpage can be updated to reflect the transmission of a new information-bearing image, and the sender can be notified of the update, as well as any bearing the new information might have on the play of a game or progress toward a reward. Once a direct relationship is established with a sender, a wide range of further interactivity is possible.

### BRIEF DESCRIPTION OF THE DRAWING FIGURES

FIG. 1 is side view of a cup containing a code arranged for imaging and uploading to a host site.

FIG. 2 is a diagram of communication links between a mobile phone user and a host site.

FIG. 3 is a diagram showing a central web site of the host and various connections.

FIG. 4 is a side view of a cup containing a dice code for uploading to a host site

FIG. 5 depicts a pair of dice using conventional spots to reveal and encode information.

FIG. 6 depicts a pair of dice using differently shaped or colored spots to reveal and encode information.

### DETAILED DESCRIPTION OF THE INVENTION

One particular implementation of the invention involves a digital form of a promotional game, such as McDonald's® popular Monopoly®-type game promotion. A machine-readable code, such as barcode or other printed encoding mechanisms, can be incorporated into game pieces that can be placed on or directly printed onto product containers. The codes for most pieces can be in a fixed form, but for certain high value pieces, the codes could be variably imaged and serialized.

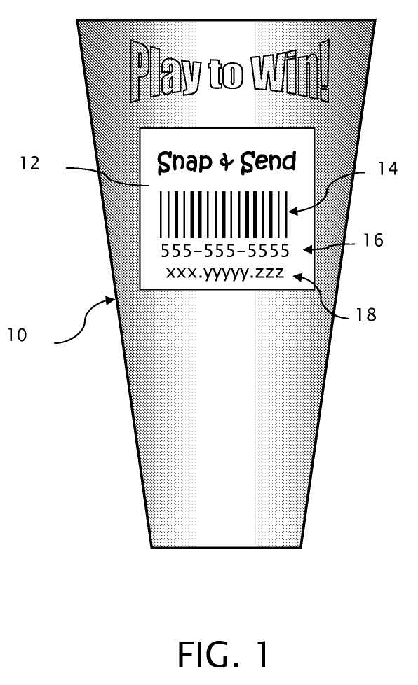

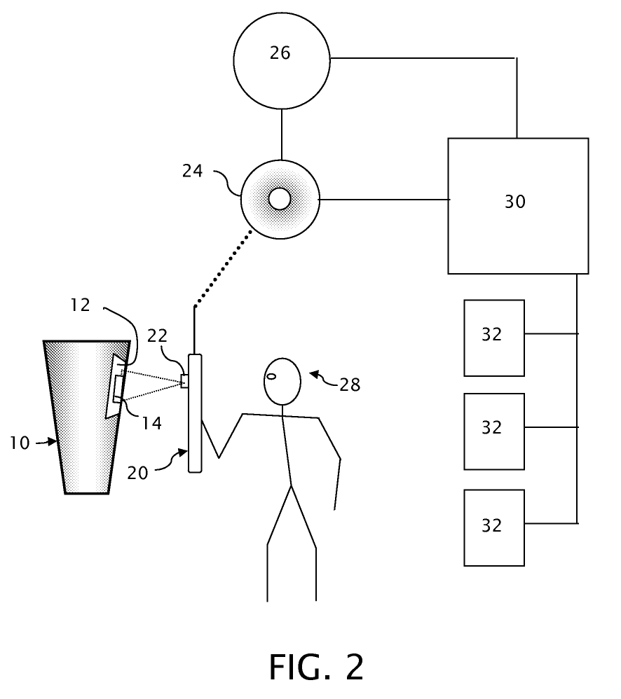

For example, FIG. 1 depicts a cup 10 on which a game piece 12 in the form of a label is placed. The game piece 12 contains a barcode 14, as well as both a telephone number 16 and a web address 18 for uploading an image of the barcode 14 with a mobile phone 20 to a host site 30 as shown in FIG. 2. The mobile phone 20 preferably takes the form of a wireless, cellular phone but can be any type of long-range, portable, imaging capable, electronic device used for mobile communication.

A participant 28 can play the game by first imaging the code 14 on the game piece 12 with a camera 22 of the mobile phone 20. Next, the participant 28 uploads the image or information locally derived from the image to the host site 30 through a telephone network connection 24 (e.g. a wireless network), a computer network connection 26 (e.g., the internet), or a combination of the two networks 24 and 26. For example, a wireless telephone network can support a telephone-to-telephone connection or a telephone-to-website connection, such as for mobile phones containing a web browser.

The host site 30, which can be managed by a game administrator, preferably decodes the image, identifies the participant 28, such as through a mobile phone identifier or locator, and creates or enters information into a personal webpage 32 for each participant 28. For example, the host site 30 can collect virtual game pieces on the page 32. Through a web browser, the participant 28 can access the page 32 to see what pieces have been collected, all without requiring the physical removal and mounting of removable game pieces.

In such virtual games, options for assigning value to various outcomes can be better controlled and even varied to accommodate the preferences of particular participants 28. For example, the game can be organized in such a way that if a matching set of properties were collected, the participant could cash them in for a choice of prizes redeemable in a number of different ways. For example, free food or merchandise could be awarded by sending the participant 28 a redemption code directly on the participant's mobile phone 20 that could be taken to a store register within the host's promotional network to receive the awarded product. Cross promotions are also possible, including awarding Coke® rewards, iTunes®, ring tones, free wallpaper, access to other internet games, free airtime, a broadband demo, and discounts on other products.

Game themes can also be tied to particular rewards, such as the collection of railroad properties could be tied to discounts for online travel services. The travel rewards can be customized to the geographic area from which the participant's phone call is placed. Return communications to the participant 28 can include text messaging, picture messaging, internet responses, and even telephone calls. For example, the participant 28 could receive a telephone call awarding a prize or directing the participant 28 as to how the prize can be collected. The call itself could be a reward, such as a call from a celebrity.

Web-based versions of such promotions could allow the participant to choose among different “skins”, which provide different graphic themes for the underlying game or other interactive promotion. These themes could be customized to fit specific demographic profiles. For example, some participants might prefer a sport theme while other participants might prefer a TV or other entertainment-based themes. This makes it possible to use high volume distribution of game pieces but still provide very specific targeted marketing appealing to a range of different people.

The participants 28 can be identified by their telephone number and the location from which their call was placed. The telephone numbers themselves may provide access to other information for identifying the participants 28. In addition, the participants 28 can choose to provide additional information about themselves in return for access privileges to a virtual promotional (e.g., gaming) space. Additional routes of communication can be opened in this way for contacting the participants 28 by postal mail addresses, internet addresses, or other telephone numbers. The virtual games and other promotional opportunities offered to participants 28 allow many more interesting play options, such as token movements on a personalized virtual game boards and awarding loyalty points for achieving certain goals in the game. In the Monopoly® game, Chance and Community Chest cards can be used to trigger treasure-hunt-type activities and additional value can be associated with game-based activities such as passing GO.

Instant rewards returned to the participant's mobile phone include free products or discounts made available at a designated vendor closest to where the participant's call is placed. These rewards could be managed by sending to the participant's mobile phone 20 a text message containing a one-time use validation key that could be entered at the local vendor's register having a separate connection to the host.

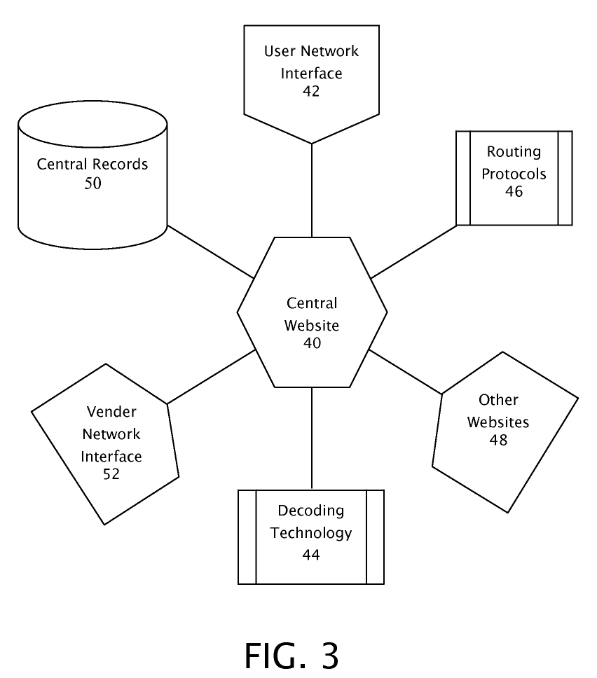

As shown in FIG. 3, a central website 40 can be provided by the host for (a) receiving information-bearing images through a network interface 42, (b) decoding the information-bearing images using decoding technology 44 that converts images to alphanumeric data, and (c) directing the participant 38 through routing protocols 46 to other websites 48 based on the contents of the transmitted information-bearing image or information relating to the identity of the participant 28, such as the telephone number or location of the sender. For example, participants 28 in one section of the country or even a more specific location within the country could be directed to one website and other participants placing calls from different locations could be directed to other websites based on the perceived demographic preferences or characteristics associated with the sender's location or other information.

The central website 40 for receiving and routing information-laden images for a given promotion provides for enhanced security for both the host 30 and the participant 28. Of course, more than one website could be used as a trusted site for receiving and decoding information, but communication between such sites would also be of value to detect instances of attempted fraud. Central records 50 can be kept regarding the activity of individual mobile phone numbers. For example, attempts to submit a large number of information-bearing images over a short period of time and over the same mobile phone could be used to trigger a security alert for that particular mobile phone number and given its approximate location. Suspected fraud could be traced to the mobile phone owner, which could be used to discourage employee theft. High-value information-bearing images could be serialized to provide traceability, or all of the images could be serialized. Through a vender network interface 52, products or their packaging containing information-bearing images can be scanned at the vendor's place of business, such as at a register, and uploaded to activate embedded codes so that no information-bearing image has value unless the product or package (e.g., cup 10) on which it is printed is first passed through the register. The codes contained within the information-bearing images could also be entered and received only once before being deactivated.

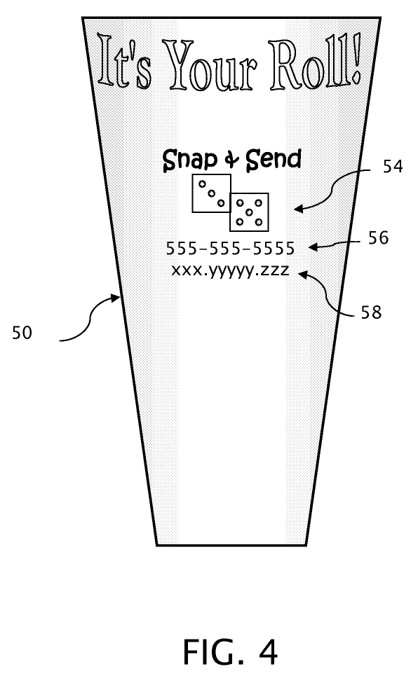

The information-bearing images can contain hidden information or decodable information that is incorporated as a part of the graphics themselves. For example, as shown in FIG. 4, a code 54 in the form of dice could be printed directly on a product container 50 as shown or on a separate substrate attached to the container 50. The dice code 54 can represent both a value meaningful to the participant 28 (e.g., a roll of eight) for the intended play of a game as well as an underlying code that further characterizes the information-bearing image. The underlying code can be interpreted as a unique number that drives an online game. The number could be translated into a meaningful action based on both the visible display of the dice code 54 as a number value to the participant (e.g., eight) and the underlying code that distinguishes the same dice combinations of one image from another. Like other information-bearing images, the dice code 54 could be captured by the mobile phone 20, a digital camera, a fax, or even a webcam. It is the further communication to the host that allows the game to be played or a promotion to be advanced.

In an elemental form, the dice code 54 could be used as an equivalent of a one-dimensional or a two-dimensional barcode, but having a much more pleasing aesthetic appearance, in addition to providing the possibility for being integrated as a visually apparent event into the intended game. Easily, the number of dots could be interpreted to mean a number. However, by equating relevance to position, many more permutations are possible.

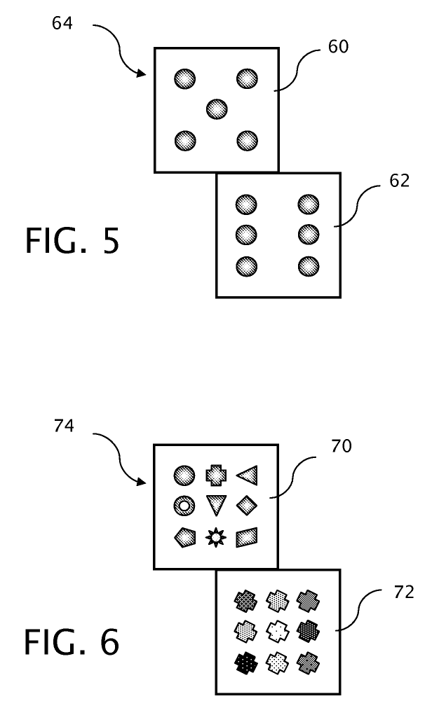

For example, as apparent from the enlarged view of FIG. 5, each die 60 and 62 of a dice code 64 has ample room for nine positions. The use of square geometry and an asymmetric position of the two dice 60 and 62 provide for easy orientation and scaling of the data-containing positions. The relevant position and orientation of the dice can add additional permutations, where in addition to spots on the dice, any location in the image can be a potential bearer of relevant information. For example, dice 70 and 72 of a dice code 74 of FIG. 6 illustrate other permutations of the dice code including use of colors (shown as shades) or spots of different shapes, such as triangles, square, circles, or even lucky charms symbols, which can themselves be exploited for encoding more information.

With dice as an iconic component of board games and their wide association with games of chance, the use of dice images to convey game-related information is considered particularly expedient. Other graphic images having intrinsic numeric or other potential gaming significance can be used to similarly encode information for playing virtual games. For example, images of slot machine reels or dart boards with embedded darts can be given a numeric interpretation by the host beyond the significance that the reel images otherwise convey. An image of a roulette wheel could be used to the same effect.

Regardless of the image or its apparent content, the value of the captured image is determined based on the underlying code that is extracted by the host 30. The meaning of the underlying codes is known only to the host or the host's administrator. Thus, the information-bearing images do not need to be hidden from view. In fact, even at the host 30, the response to a particular code does not necessarily need to be preprogrammed. The code could be categorized based on its location and time of day, and a response, including a winning response, could be fashioned to match the additional available information. For example, in the early hours of the morning, a breakfast sandwich might be awarded whereas later in the day, free French fries might be offered. The reward could also be matched to ongoing geographically limited promotions. Even a determination as to whether the code is a winner or a loser could be determined on a random or changing basis. A database of released codes (i.e. codes embedded in printed images that are publicly distributed) could be maintained and each attempted redemption could be checked against the database to assure that the assigned number is redeemed but once.

Some cost is associated with both the transmission of images to the host 30 and any response from the host 30 or subsequent site to the participant's mobile phone 20. The potential rewards and even game play itself are incentives for mobile phone users to participate. The cost of returned communications would preferably be borne by the host promoter. The host promoter's motivation is also high as an opportunity to obtain direct access and interaction with individual customers. These customers are likely to be persons who have already purchased a product of the host promoter or have acquired the images from one of the host promoter's sites (physical or virtual). The demographics of interactive mobile phone users is also expected to be particularly appealing to promoters.

The invention can be practiced as a promotional exercise in the form of an interactive game that includes a printed graphic, such as the code 14 of FIG. 1, bearing information capable of being machine decoded. A mobile phone, such as the mobile phone 20, or other image-capturing device with internet or phone access can be used to capture the printed graphic 14 and to transmit an image of the captured graphic to a host computer, such as the host site 30. A participant, such as the participant 28, takes a picture of the printed graphic 14 and instructions within or associated with the printed graphic enable participants to send the picture to the host computer 30. The host computer 30 processes the picture to extract the machine-readable information. The extracted information can be used to trigger a response, which can be performed directly by the host computer 30 or transmitted to another computer or program, such as to create an event within an online game. The event is attributable to an individualized account, such as a web page 32, referenced, for example, to the participant's mobile phone number. The event furthers the participant's interaction with the game. A sign-on protocol can be established for more securely connecting the participant 28 with their individualized account 32 for allowing access at other times.

Preferably, the printed image appears as an aesthetically pleasing graphic despite encoding information necessary to the play of the game or advancement of the intended promotion. For example, the graphic can be in the form of dice, such as the dice code 54, 64, or 74, whose spot layout, spot content, and relative positions among two or more die can be used to encode additional information beyond the obvious appearance of the dice. The host computer 30 or a related link can store the event triggered by the decoding of the picture under a phone-number-based identification until the participant 28 claims the event from a personalized online account at a later time. An instant response is also preferably generated by the host computer 30 or another computer to which at least some of the information is routed.

Upon receiving the transmission of a picture and decoding its contents, the host computer 30 can determine from the telephone number associated with the transmission whether an online account has already been established or not. If not, an instant response is preferably sent to the participant's phone 20 providing details through which the participant 28 can so establish an account, either through the participant's mobile phone 20 or through another internet connection. Any instant awards, offers, or information related to the progress of the game can also be instantly conveyed to the user.

Although described with respect to a limited number of embodiments, those of skill in this art will appreciate the modifications and different combinations that have been made possible within the teaching of this invention. For example, the imageable codes subject to transmission to host sites by mobile phones can appear, not only on products or product containers, but also on promotional materials, such as advertisements or coupons, or on places of business

1. A method of conducting a promotion comprising steps of
receiving an information-bearing image captured with a camera of a sender's mobile phone,
acquiring information concerning the sender of the information-bearing image,
extracting information from the information-bearing image,
processing information extracted from the information-bearing image, and
replying to the sender to engage the sender in a promotion.

2. The method of claim 1 in which the step of replying includes downloading an acknowledgement receipt of the information-bearing image to the sender's mobile phone.

3. The method of claim 1 in which the step of replying includes downloading a promotional award to the sender's mobile phone.

4. The method of claim 1 in which the step of replying includes downloading instructions for participating in the promotion to the sender's mobile phone.

5. The method of claim 1 including a further step of establishing a link between the sender and a website.

6. The method of claim 5 including a step of linking the information from the information-bearing image to the website.

7. The method of claim 5 in which the website includes a webpage unique to the sender.

8. The method of claim 7 in which the webpage is modified by the information from the information-bearing image.

9. The method of claim 7 in which the step of replying includes downloading information about accessing the new webpage to the sender's mobile phone.

10. The method of claim 7 including a step of directing a browser of the sender's mobile phone to the webpage.

11. The method of claim 7 including a step of choosing the webpage from a number of available web pages based on the information about at least one of (a) the information-bearing image and (b) the sender.

12. The method of claim 7 in which the webpage has been previously associated with the sender and including a step of updating the sender's webpage based on the information-bearing image received from the sender's mobile phone.

13. The method of claim 12 including a step of notifying the sender of the update to the sender's webpage.

14. The method of claim 1 in which the step of acquiring information includes acquiring information about the sender from a network transmitting the information image.

15. The method of claim 14 in which the information about the sender includes at least one of (a) a telephone number of the sender's mobile phone and (b) the route of the call to the host site.

16. A host for a promotional enterprise comprising
a central website for receiving information-bearing images from a participant through a mobile phone network,
a network interface for acquiring information about participants through the mobile phone network,
a processor with protocols for generating a replies to the participants based on both information extracted from the information-bearing images and the information acquired about the participants.

17. The host of claim 16 further comprising decoding technology for decoding the information-bearing images received by the central website.

18. The host of claim 16 in which the information acquired about the participants includes locations of the participants and the replies are based at least in part on the locations of the participants.

19. The host of claim 18 in which time-of-day information is also associated with the receipt of the information-bearing images and the replies are based at least in part on the time of day at which the information-bearing images are received from the acquired locations.

20. The host of claim 16 further in which the processor contains routing protocols for directing the participants to individual web pages.

21. The host of claim 20 in which the individual web pages are updated by the receipt of additional information-bearing images associated with previously identified participants.

22. The host of claim 20 further comprising a vendor network interface for activating codes extracted from the information-bearing images to defer rewards to participants until the codes associated with the information-bearing images are activated.

23. The host of claim 22 in which the vendor network interface is linked to a vendor's place of business for activating the codes associated with the information-bearing images upon sale of goods bearing the information-bearing images.

24. A mobile-phone based promotional enterprise involving capturing information-bearing images by a mobile phone camera as electronic images and transmitting the image information to a host computer for processing and response in which the information-bearing images are graphic codes having both a visually apparent meaning and a hidden meaning decodable from the electronic images of the graphic codes.

25. The enterprise of claim 24 in which the graphic codes are decodable for extracting information as an alphanumeric sequence that is not visibly apparent.

26. The enterprise of claim 24 in which the graphic codes appear as dice having a visually apparent numeric value and an arrangement of visible features decodable according to a key for revealing the hidden meaning.

27. The enterprise of claim 26 in which the visible features include spots that vary among each other to encode meaning.

28. The enterprise of claim 27 in which the dice are relatively positioned to encode further meaning.

29. The enterprise of claim 26 in which the response is based on both the visually apparent meaning and the hidden meaning decodable from the electronic images of the graphic codes.

30. The enterprise of claim 24 in which the graphic codes appear as a dart board with embedded darts having a visually apparent numeric value and an arrangement of visible features decodable according to a key for revealing the hidden meaning.

31. The enterprise of claim 24 in which the graphic codes appear as a slot machine wheel having a visually apparent numeric value and an arrangement of visible features decodable according to a key for revealing the hidden meaning.

32. The enterprise of claim 24 in which the graphic codes appear as a roulette wheel having a visually apparent numeric value and an arrangement of visible features decodable according to a key for revealing the hidden meaning.
